(19) United States
(12) Patent Application Publication
(10) Pub. No.: US 2024/0045900 A1
(43) Pub. Date: Feb. 8, 2024

(54) SEARCH SYSTEM, SEARCH METHOD, AND COMPUTER PROGRAM

(71) Applicant: NEC Corporation, Minato-ku, Tokyo (JP)

(72) Inventor: Masashi FUJITSUKA, Tokyo (JP)

(73) Assignee: NEC Corporation, Minato-ku, Tokyo (JP)

(21) Appl. No.: 18/269,043

(22) PCT Filed: Dec. 24, 2020
(86) PCT No.: PCT/JP2020/048474

§ 371 Date: Jun. 22, 2023

(51) Int. Cl. G06F 16/532; G06V 20/68; G06V 10/77; G06F 16/583; G06F 16/56; G06F 40/40

(52) U.S. Cl. CPC G06F 16/532; G06V 20/68; G06V 10/7715; G06F 16/583; G06F 16/56; G06F 40/40

(57) ABSTRACT

A search system includes: a sentence generation unit that generates a sentence corresponding to an object included in an image by using a learned model; an information addition unit that adds the sentence corresponding to the object, to the image as an adjective information of the object; a query acquisition unit that obtains a search query; and a search unit that searches for an image corresponding to the search query, from a plurality of images, on the basis of the search query and the adjective information. According to such a search system, it is possible to realize a search using various properties of an object in an image.

### TECHNICAL FIELD

The present invention relates to a search system, a search method, and a computer program for searching for an image, for example.

### BACKGROUND ART

A known system of this type searches for a desired image from a plurality of images. For example, Patent Literature 1 discloses a technique/technology of searching for a score that is an image evaluation expression by comparing it with a predetermined threshold and then extracting a matching image. Patent Literature 2 discloses a technique/technology of extracting a feature work and searching for a description information about an image. Patent Literature 3 discloses a technique/technology of searching for an image by using a feature quantity of an image and an adjective-pair evaluation value.

As another related technique/technology, Patent Literature 4 discloses a technique/technology of extracting a feature quantity for each word string by performing a series process on an obtained text. Patent Literature 5 discloses a technique/technology of classifying a set of a feature quantity of an image and a feature quantity of a texts into a plurality of classes.

### CITATION LIST

### Patent Literature

Patent Literature 1: JP2017-151588A
Patent Literature 2: JP2019-536122A
Patent Literature 3: JP2016-218708A
Patent Literature 4: JP2020-157168A
Patent Literature 5: JP2015-041225A

### SUMMARY

### Technical Problem

In order to search for an image, an object included in an image may be provided with information indicating a state and a situation thereof. It may be, however, not easy to analyze the image and provide proper information.

In view of the above-described problems, it is an example object of the present invention to provide a search system, a search method, and a computer program that are allowed to realize a search using various properties of an object in an image.

### [Unit for Solving the Problem]

A search system according to an example aspect of the present invention includes: a sentence generation unit that generates a sentence corresponding to an object included in an image by using a learned model; an information addition unit that adds the sentence corresponding to the object, to the image as an adjective information of the object; a query acquisition unit that obtains a search query; and a search unit that searches for an image corresponding to the search query, from a plurality of images, on the basis of the search query and the adjective information.

A search method according to an example aspect of the present invention includes: generating a sentence corresponding to an object included in an image by using a learned model; adding the sentence corresponding to the object, to the image as an adjective information of the object; obtaining a search query; and searching for an image corresponding to the search query, from a plurality of images, on the basis of the search query and the adjective information.

A computer program according to an example aspect of the present invention operates a computer: to generate a sentence corresponding to an object included in an image by using a learned model; to add the sentence corresponding to the object, to the image as an adjective information of the object; to obtain a search query; and to search for an image corresponding to the search query, from a plurality of images, on the basis of the search query and the adjective information.

### Effect of the Invention

According to the search system, the search method, and the computer program in the respective aspects described above, it is possible to realize a search using various properties of an object in an image.

### BRIEF DESCRIPTION OF DRAWINGS

FIG. 1 is a block diagram illustrating a hardware configuration of a search system according to a first example embodiment.

FIG. 2 is a block diagram illustrating a functional configuration of the search system according to the first example embodiment.

FIG. 3 is a flowchart illustrating a flow of an information addition operation of the search system according to the first example embodiment.

FIG. 4 is a diagram illustrating an example of a set of an image and a text used for learning of a sentence generation unit according to the first example embodiment.

FIG. 5 is a flowchart illustrating a flow of a search operation of the search system according to the first example embodiment.

FIG. 6 is a block diagram illustrating a functional configuration of a search system according to a second example embodiment.

FIG. 7 is a flowchart illustrating a flow of an information addition operation of the search system according to the second example embodiment.

FIG. 8 is a conceptual diagram illustrating a specific operation of the sentence generation unit according to the second example embodiment.

FIG. 9 is a block diagram illustrating a functional configuration of a search system according to a third example embodiment.

FIG. 10 is a flowchart illustrating a flow of a search operation of the search system according to the third example embodiment.

FIG. 11 is a block diagram illustrating a functional configuration of a search system according to a fourth example embodiment.

FIG. 12 is a flowchart illustrating a flow of an information addition operation of the search system according to the fourth example embodiment.

FIG. 13 is a conceptual diagram illustrating a specific operation of an object detection unit according to the fourth example embodiment.

FIG. 14 is a block diagram illustrating a functional configuration of an information addition system according to a fifth example embodiment.

### DESCRIPTION OF EXAMPLE EMBODIMENTS

Hereinafter, a search system, a search method, and a computer program according to example embodiments will be described with reference to the drawings.

### First Example Embodiment

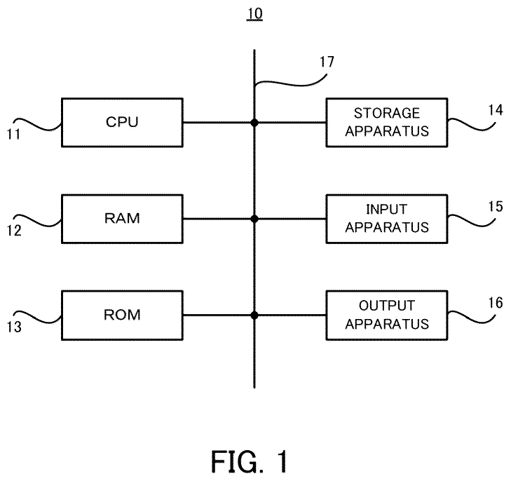

A search system according to a first example embodiment will be described with reference to FIG. 1 to FIG. 5.

### (Hardware Configuration)

First, a hardware configuration of the search system according to the first example embodiment will be described with reference to FIG. 1. FIG. 1 is a block diagram illustrating the hardware configuration of the search system according to the first example embodiment.

As illustrated in FIG. 1, a search system 10 according to the first example embodiment includes a processor 11, a RAM (Random Access Memory) 12, a ROM (Read Only Memory) 13, and a storage apparatus 14. The search system 10 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium by using a not-illustrated recording medium reading apparatus. The processor 11 may obtain (i.e., may read) a computer program from a not-illustrated apparatus disposed outside the search system 10, through a network interface. The processor 11 controls the RAM 12, the storage apparatus 14, the input apparatus 15, and the output apparatus 16 by executing the read computer program. Especially in this example embodiment, when the processor 11 executes the read computer program, a functional block for performing a process of generating a sentence from an image and giving an adjective information and a process of searching for an image by using the adjective information is realized or implemented in the processor 11. An example of the processor 11 includes a CPU (Central Processing Unit), a GPU (Graphics Processing Unit), a FPGA (field-programmable gate array), a DSP (Demand-Side Platform), and an ASIC (Application Specific Integrated Circuit). The processor 11 may use one of the above examples, or may use a plurality of them in parallel.

The RAM 12 temporarily stores the computer program to be executed by the processor 11. The RAM 12 temporarily stores the data that is temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that is stored for a long term by the search system 10. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the search system 10. The input apparatus 15 may include, for example, at least one of a keyboard, a mouse, and a touch panel. The input apparatus 15 may be a dedicated controller (operation terminal). The input apparatus 15 may also include a terminal owned by the user (e.g., a smartphone or a tablet terminal, etc.). The input apparatus 15 may be an apparatus that allows an audio input including a microphone, for example.

The output apparatus 16 is an apparatus that outputs information about the search system to the outside. For example, the output apparatus 16 may be a display apparatus (e.g., a display) that is configured to display the information about the search system 10. The display apparatus here may be a TV monitor, a personal computer monitor, a smartphone monitor, a tablet terminal monitor, or another portable terminal monitor. The display apparatus may be a large monitor or a digital signage installed in various facilities such as stores. The output apparatus 16 may be an apparatus that outputs the information in a format other than an image. For example, the output apparatus 16 may be a speaker that audio-outputs the information about the information processing apparatus 10.

### (Functional Configuration)

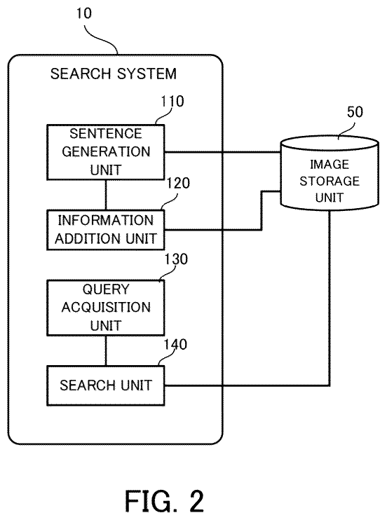

Next, a functional configuration of the search system 10 according to the first example embodiment will be described with reference to FIG. 2. FIG. 2 is a block diagram illustrating the functional configuration of the search system according to the first example embodiment.

As illustrated in FIG. 2, the search system 10 according to the first example embodiment includes, as processing blocks for realizing the functions thereof, a sentence generation unit 110, an information addition unit 120, a query acquisition unit 130, and a search unit 140. Each of the sentence generation unit 110, the information addition unit 120, the query acquisition unit 130, and the search unit 140 may be realized or implemented by the processor 11 (see FIG. 1), for example. Furthermore, the search system 10 is configured to read and rewrite a plurality of images stored in an image storage unit 50 as appropriate. Although the image storage unit 50 is used as an apparatus external to the search system 10, the image storage unit 50 may be provided in the search system 10. In this case, the image storage unit 50 may be realized or implemented by the storage apparatus 14 (see FIG. 1), for example.

The sentence generation unit 110 is configured to generate a sentence corresponding to an object included in an image by using a learned model. Here, the “sentence corresponding to the object” is a sentence indicating what type of object is included in the image, and includes an adjective information (e.g., a common adjective, a word that describes the object, etc.). A plurality of sentences may be generated by the sentence generation unit 110. An amount of the sentence generated by the sentence generation unit 110 may be set in advance by a system administrator, a user, or the like, or may be determined as appropriate on the basis of an analysis result of the image. The learned model for generating the sentence will be described in detail in another example embodiments described later. The following example exemplifies that the sentence corresponding to the object, which is generated by the sentence generation unit 110, is a Japanese sentence. The sentence corresponding to the object, which is generated by the sentence generation unit 110, is configured to be outputted to the information addition unit 120.

The information addition unit 120 is configured to add the sentence corresponding to the object, which is generated in the sentence generation unit 110, to the image as the adjective information. More specifically, the information addition unit 120 stores the object included in the image and the sentence corresponding to the object in the image storage unit 50 in association with each other. The “adjective information” here is information indicating a state and a situation of the object. For example, when the object included in an image is a “dish”, the adjective information thereof may include information indicating a taste (sweetness, spiciness, saltiness, etc.), smell, temperature (heat, coolness), or the like of the dish. Alternatively, when the object included in an image is an “article (e.g., a product sold at a shopping site or a store, etc.)”, the adjective information thereof may include information indicating a texture, a tactile feel, or the like of the article. Furthermore, the adjective information may include information indicating a degree of the above information (i.e., information indicating the state or situation of the object). For example, the adjective information indicating the spiciness of the dish may be not only “spicy”, but also information such as “very spicy”, “slightly spicy”, and “mild spiciness”. Furthermore, the adjective information may be information including a plurality of adjectives, such as “slightly spicy, but hard but rich in flavor”. The adjective information may further be information including not only a uniform expression, but also subtle nuances based on an individual's sense. The adjective information may not be objective information, but may be subjective information (e.g., information including personal thoughts of a person who captures an image or a person who brows it). The adjective information described above is an example, and expressions other than these may be included in the adjective information.

The query acquisition unit 130 is configured to obtain a search query inputted by a user who is about to search for an image. The query acquisition unit 130 obtains the search query inputted by using the input apparatus 15 (see FIG. 1) or the like, for example. The search query here may be a natural language. For example, the search query may include a plurality of words, such as “a rich ramen that I had in Tokyo two years ago” and “an extremely spicy curry that I had in Sapporo in October”. The search query obtained by the query acquisition unit 130 is configured to be outputted to the search unit 140.

The search unit 140 is configured to search for an image corresponding to the search query from a plurality of images stored in the image storage unit 50, on the basis of the search query obtained by the query acquisition unit 130 and the adjective information added to an image by the information addition unit 120 (e.g., by comparing the search query and the adjective information). The search unit 140 may have a function of outputting the image corresponding to the search query, as a search result. In this case, the search unit 140 may output the search result by using the output apparatus 16. The search unit 140 may output a single image that best matches the search query, or may output a plurality of images that match the search query. A specific search method by the search unit 140 will be described in detail in another example embodiment described later.

### (Information Addition Operation)

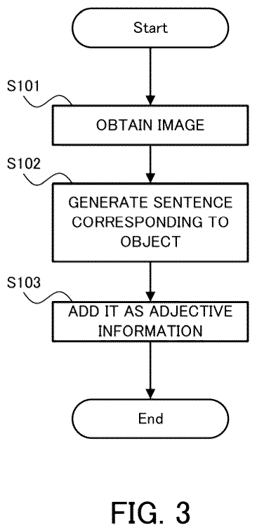

Next, an operation of adding the adjective information (hereinafter referred to as an “information addition operation”) that is performed by the search system 10 according to the first example embodiment will be described with reference to FIG. 3. FIG. 3 is a flowchart illustrating a flow of the information addition operation of the search system according to the first example embodiment.

As illustrated in FIG. 3, when the information addition operation by the search system 10 according to the first example embodiment is started, first, the search system 10 obtains an image from the image storage unit 50 (step S101). The image obtained here is an image to which the adjective information is not yet added (e.g., the information addition operation is not yet performed), out of a plurality of images stored in the image storage unit 50. The image may be obtained from other than the image storage unit 50. For example, the image may be automatically obtained from the Internet (e.g., shopping sites, review sites, etc.). Alternatively, the image may be directly inputted to the search system 10 by a system administrator, a user, or the like.

Subsequently, the sentence generation unit 110 uses the obtained image and generates a sentence corresponding to an object included in the image (step S102). Then, the information addition unit 120 adds the sentence generated by the sentence generation unit 110, to the image as the adjective information (step S103).

A series of processing steps described above may be continuously performed for each of the plurality of images. That is, a process of generating a sentence for a first image and adding the sentence as the adjective information, is performed, and then, a process of generating a sentence for a second image and adding the sentence as the adjective information, is performed. The information addition operation may be performed for all the images stored in image storage unit 50 by repeatedly performing the operation in this manner.

### (Data for Learning)

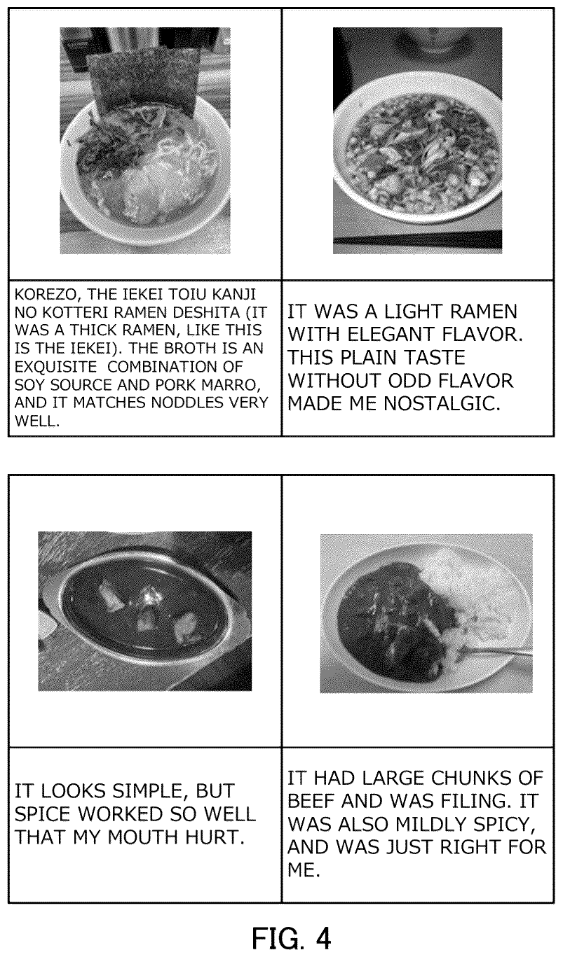

Next, data for learning (i.e., training data) used for learning of the sentence generation unit 110 will be specifically described with reference to FIG. 4. FIG. 4 is a diagram illustrating an example of a set of an image and a text used for the learning of the sentence generation unit according to the first example embodiment.

In order to perform the information addition operation (see FIG. 3), the sentence generation unit 110 includes a learned model for generating a sentence from an image. The learned model includes, for example, a neural network or the like, and is machine-learned by using training data before starting the information addition operation.

As illustrated in FIG. 4, the learned model may use a set of an image and a sentence (i.e., text data) corresponding to an object included in the image, as the training data. In the example illustrated in the figure, the set includes images of ramen and curry, and text data including thoughts when a person eats the ramen and the curry. By using such training data, it is possible to generate a model for generating a sentence including the adjective information of a dish when an image including the dish is inputted, for example.

The above training data is an example, and an image including an object other than the dish may be used as the training data. In addition, not the text data including the thoughts on an object, but text data including a sentence describing the state of the object or the like, may be used as the training data. That is, a type of the training data is not particularly limited as long as it is a set of an image including an object and text data including a sentence corresponding to the object.

### (Search Operation)

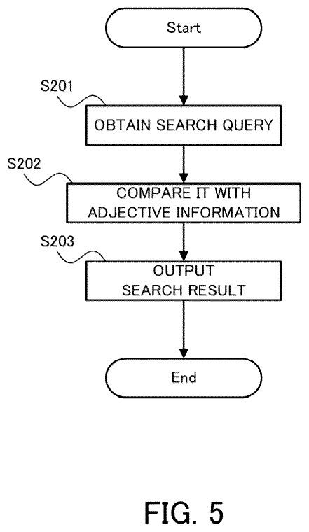

Next, an operation of searching for an image (hereinafter referred to as a “search operation” as appropriate) by the search system 10 according to the first example embodiment will be described with reference to FIG. 5. FIG. 5 is a flowchart illustrating a flow of the search operation of the search system according to the first example embodiment.

As illustrated in FIG. 5, when the search operation by the search system 10 according to the first example embodiment is started, first, the query acquisition unit 130 obtains a search query (step S201). The obtained search query is outputted to the search unit 140.

Subsequently, the search unit 140 compares the search query obtained by the query acquisition unit 130 with the adjective information added to an image (step S202). The search unit 140 outputs an image corresponding to the search query as a search result (step S203). The search unit 140 not only compares the search query with the adjective information, but also may output the search result on the basis of the search query and the adjective information.

The search unit 140 may perform a search by using another information about an object and an image, in addition to the adjective information. Specifically, at least one of a time information indicating a time when an image is captured, a positional information indicating a position where an image is captured, and a name information indicating a name of an object may be used to perform a search. In this case, the time information may be obtained from a timestamp of the image. The position information may be obtained from a GPS (Global Positioning System). The name information may be obtained from an object detection information from the image (described in detail in another example embodiment described later).

A search target of the search unit 140 may be a plurality of images included in video data (i.e., images of each frame of the video data). In this case, the image corresponding to the search query may be outputted as the search result, or the video data including the image corresponding to the search query may be outputted as the search result.

### (Technical Effect)

Next, a technical effect obtained by the search system 10 according to the first example embodiment will be described.

As described in FIG. 1 to FIG. 5, in the search system 10 according to the first example embodiment, a sentence corresponding to an object included in an image is automatically generated and is added as the adjective information. The adjective information is then used to search for an image. In this way, it is possible to properly search for the user's desired image by using the adjective information added as the sentence.

The dictionary registration of the adjective information in advance makes it possible to perform a search using the adjective information without generating a sentence as in this example embodiment; however, for example, the adjective information that cannot be expressed by a single expression (e.g., “it is spicy, and yet has a sweet taste of a vegetable”, etc.) is hardly registered in a dictionary one by one. According to the search system 10 in this example embodiment, however, an automatically generated sentence is added as the adjective information, and it is thus possible to perform an image search using the adjective information that cannot be expressed by a single expression.

Furthermore, according to the search system 10 in this example embodiment, not only a uniform adjective information, but also information including subtle nuances based on an individual's sense and unique information about an experience that an individual had on the spot, may be used as the adjective information. It is possible to have the user record such information, but it is a very troublesome task for the user to record the information at each time. According to the search system 10 in this example embodiment, however, a sentence is automatically generated by the learned model, and thus, it does not increase the user's labor.

### Second Example Embodiment

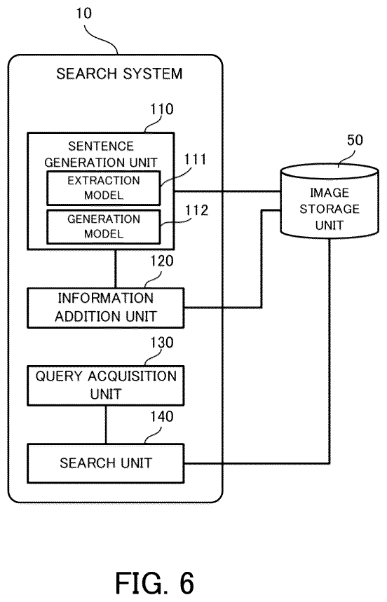

The search system 10 according to a second example embodiment will be described with reference to FIG. 6 to FIG. 8. The second example embodiment is partially different from the first example embodiment only in the configuration and operation, and is generally the same in the other parts. For this reason, a part that is different from the first example embodiment will be described in detail below, and a description of the other overlapping parts will be omitted as appropriate.

### (Functional Configuration)

First, a functional configuration of the search system 10 according to the second example embodiment will be described with reference to FIG. 6. FIG. 6 is a block diagram illustrating the functional configuration of the search system according to the second example embodiment. In FIG. 6, the same components as those illustrated in FIG. 2 carry the same reference numerals.

As illustrated in FIG. 6, the search system 10 according to the second example embodiment includes, as processing blocks for realizing the functions thereof, the sentence generation unit 110, the information addition unit 120, the query acquisition unit 130, and the search unit 140. In particular, the sentence generation unit 110 according to the second example embodiment includes two models that are an extraction model 111 and a generation model 112, as the learned model.

The extraction model 111 is configured to extract, from an inputted image, a feature quantity of an object included in the image. The feature quantity here indicates the feature quantity of the object, and is usable in generating a sentence corresponding to the object. The extraction model 111 may be configured as a CNN (Convolutional Neural Network), such as a ResNet (Residual Network) and an EfficientNet. Alternatively, the extraction model 111 may be configured as an image feature quantity extractor, such as a color histogram and an edge. A detailed description of a method of extracting the feature quantity from the image by using such a model will be omitted here, because existing techniques/technologies can be adopted to the method as appropriate.

The generation model 112 is configured to generate a sentence corresponding to the object, from the feature quantity extracted by the extraction model 111. The generation model 112 may be configured as a LSTM (Long Short Term Memory) decoder, for example. The generation model 112 may also be configured as a Transformer. A detailed description of a method of generating the sentence from the feature quantity by using such a model will be omitted here, because existing techniques/technologies can be adopted to the method as appropriate.

### (Information Addition Operation)

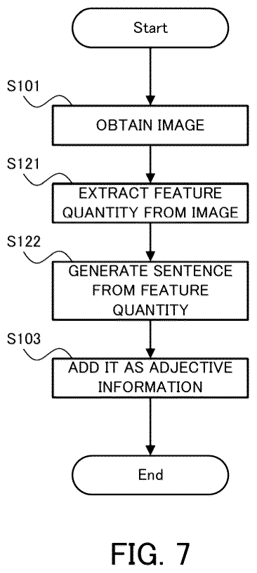

Next, an information addition operation by the search system 10 according to the second example embodiment will be described with reference to FIG. 7. FIG. 7 is a flowchart illustrating a flow of the information addition operation of the search system according to the second example embodiment. In FIG. 7, the same steps as those illustrated in FIG. 3 carry the same reference numerals.

As illustrated in FIG. 7, when the information addition operation by the search system 10 according to the second example embodiment is started, first, the search system 10 obtains an image from the image storage unit 50 (step S101).

Subsequently, the sentence generation unit 110 extracts the feature quantity of an object from the image by using the extraction model 111 (step S121). Then, the sentence generation unit 110 generates a sentence corresponding to the object from the feature quantity by using the generation model 112 (step S122).

Then, the information addition unit 120 adds the sentence generated by the sentence generation unit 110, to the image as the adjective information (step S103).

### Specific Operation Example

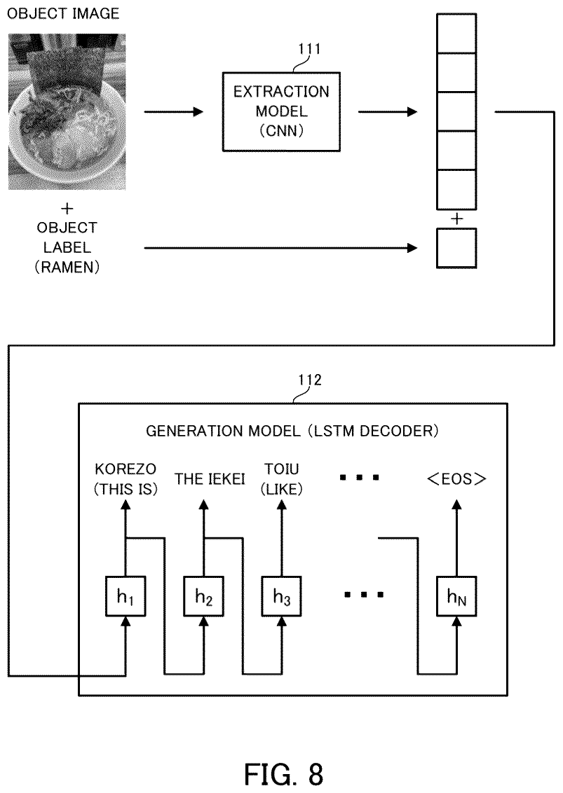

Next, a specific operation example of the search system 10 according to the second example embodiment (especially, the operation of the sentence generation unit 110) will be described with reference to FIG. 8. FIG. 8 is a conceptual diagram illustrating a specific operation of the sentence generation unit according to the second example embodiment. The following exemplifies that the extraction model 111 is configured as a CNN and the generation model 112 is configured as an LSTM decoder.

As illustrated in FIG. 8, it is assumed that an object image (an image of ramen) is inputted to the sentence generation unit 110 according to the second example embodiment. In this case, first, the extraction model 111 extracts the feature quantity of the object from the image. As illustrated in the drawing, when an object label (e.g., information indicating the name of an object) is inputted together with the object image, information about the object label may be integrated into the feature quantity extracted by the extraction model 111. The feature quantity extracted by the extraction model 111 is outputted to the generation model 112.

Subsequently, the generation model 112 generates a sentence from the feature quantity extracted by the extraction model 111. In the example illustrated in FIG. 8, a word of “korezo (this is)” is outputted from h1 of the generation model 112 (i.e., LSTM decoder), a word of “the iekei” is outputted from h2, and a word of “toiu (like)” is outputted from h3. The generation model 112 combines the words outputted in this manner to produce a sentence corresponding to the object.

### (Technical Effect)

Next, technical effects obtained by the search system 10 according to the second example embodiment will be described.

As described in FIG. 6 to FIG. 8, in the search system 10 according to the second example embodiment, the sentence generation unit 110 includes the extraction model 111 and the generation model 112, and it is thus possible to properly generate the sentence corresponding to the object from the image. The extraction model 111 and the generation model 112 may perform learning separately, or may perform learning collectively.

### Third Example Embodiment

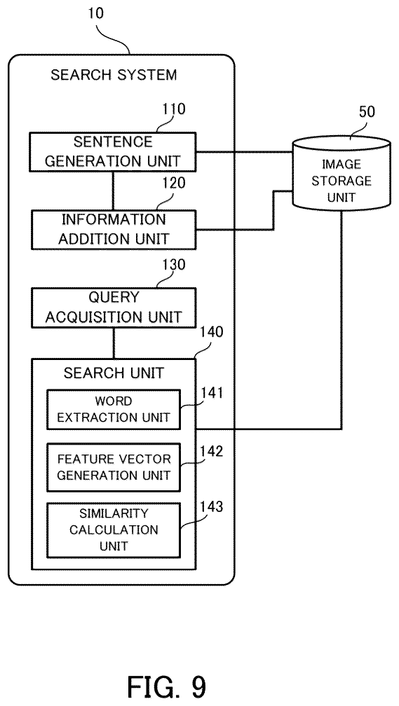

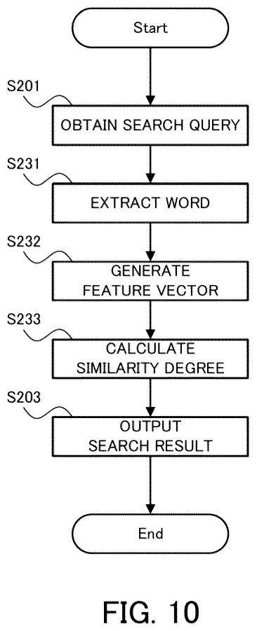

The search system 10 according to a third example embodiment will be described with reference to FIG. 9 and FIG. 10. The third example embodiment is partially different from the first and second example embodiments only in the configuration and operation, and is generally the same in the other parts. For this reason, a part that is different from the first and second example embodiments will be described in detail below, and a description of the other overlapping parts will be omitted as appropriate.

### (Functional Configuration)

First, a functional configuration of the search system 10 according to the third example embodiment will be described with reference to FIG. 9. FIG. 9 is a block diagram illustrating the functional configuration of the search system according to the third example embodiment. In FIG. 9, the same components as those illustrated in FIG. 2 carry the same reference numerals.

As illustrated in FIG. 9, the search system 10 according to the third example embodiment includes, as processing blocks for realizing the functions thereof, the sentence generation unit 110, the information addition unit 120, the query acquisition unit 130, and the search unit 140. In particular, the search unit 140 according to the third example embodiment includes a word extraction unit 141, a feature vector generation unit 142, and a similarity calculation unit 143.

The word extraction unit 141 extracts a word that is usable for the search, from the search query obtained by the query acquisition unit 130 and the adjective information added to an image. The word extraction unit 141 may extract a plurality of words from each of the search query and the adjective information. The word extracted by the word extraction unit 141 may be an adjective included in the search query and the adjective information, or may be a word other than the adjective. For the adjective information added to an image, the word may be extracted in advance (e.g., before the search operation is started). In this case, the extracted word may be stored in addition to or in place of the sentence previously stored as the adjective information. Information about the word extracted by the word extraction unit 141 is configured to be outputted to the feature vector generation unit 142.

The feature vector generation unit 142 is configured to generate a feature vector from the word extracted by the word extraction unit 141. Specifically, the feature vector generation unit 142 generates a feature vector of the search query (hereinafter referred to as a “query vector” as appropriate) from the word extracted from the search query, and generates a feature vector of the adjective information (hereinafter referred to as a “target vector” as appropriate) from the word extracted from the adjective information. A detailed description of a specific method of generating the feature vector from the word will be omitted here, because existing techniques/technologies can be adopted to the method as appropriate. The feature vector generation unit 142 may generate a single feature vector from a single word, or may generate a single feature vector from a plurality of words (i.e., a feature vector corresponding to a plurality of words). The feature vector generation unit 142 may generate the feature vector from the search query and the adjective information itself (i.e., the sentences that is not divided into words), when the word extraction by the word extraction unit 141 is not performed. The feature vector generated by the feature vector generation unit 142 (i.e., the query vector and the target vector) is configured to be outputted to the similarity calculation unit 143.

The similarity calculation unit 143 is configured to calculate a similarity degree between the query vector and the target vector generated by the feature vector generation unit 142. A specific method of calculating the similarity degree can adopt existing techniques/technologies as appropriate, but an example thereof may be a method of calculating a cosine similarity degree. The similarity calculation unit 143 calculates the similarity degree between the query vector and the target vector corresponding to each of a plurality of images, and searches for an image corresponding to the search query on the basis of the similarity degree. For example, the similarity calculation unit 143 outputs an image with the highest similarity degree as the search result. Alternatively, the similarity calculation unit 143 may output a predetermined number of images as the search result in descending order of the similarity degree.

### (Search Operation)

Next, a search operation by the search system 10 according to the third example embodiment will be described with reference to FIG. 10. FIG. 10 is a flowchart illustrating a flow of the search operation of the search system according to the third example embodiment. In FIG. 10, the same steps as those illustrated in FIG. 5 carry the same reference numerals.

As illustrated in FIG. 10, when the search operation by the search system 10 according to the third example embodiment is started, first, the query acquisition unit 130 obtains a search query (step S201). The obtained search query is outputted to the search unit 140.

Subsequently, the word extraction unit 141 of the search unit 140 extracts the word that is usable for the search, from the obtained search query and the adjective information added to an image (step S231). Then, the feature vector generation unit 142 generates the feature vector (i.e., the query vector and the target vector) from the word extracted by the word extraction unit 141 (step S232). Then, the similarity calculation unit 143 calculates the similarity degree of the query vector and the target vector and searches for an image corresponding to the search query (step S233).

Then, the search unit 140 outputs the image corresponding to the search query as a search result (step S203).

### (Technical Effect)

Next, a technical effect obtained by the search system 10 according to the third example embodiment will be described.

As described in FIG. 9 and FIG. 10, the search system 10 according to the third example embodiment performs the search by using the similarity degree of the feature vector generated from each of the search query and the adjective information. In this way, it is possible to properly compare the inputted search query with the adjective information added to an image. Consequently, it is possible to properly search for the user's desired image.

### Fourth Example Embodiment

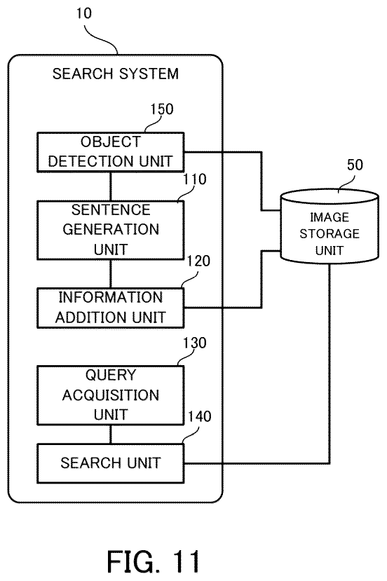

The search system 10 according to a fourth example embodiment will be described with reference to FIG. 11 to FIG. 13. The fourth example embodiment is partially different from the first to third example embodiments only in the configuration and operation, and is generally the same in the other parts. For this reason, a part that is different from the first to third example embodiments will be described in detail below, and a description of the other overlapping parts will be omitted as appropriate.

### (Functional Configuration)

First, a functional configuration of the search system 10 according to the fourth example embodiment will be described with reference to FIG. 11. FIG. 11 is a block diagram illustrating the functional configuration of the search system according to the fourth example embodiment. In FIG. 11, the same components as those illustrated in FIG. 2 carry the same reference numerals.

As illustrated in FIG. 11, the search system 10 according to the fourth example embodiment includes, as processing blocks for realizing the functions thereof, an object detection unit 150, the sentence generation unit 110, the information addition unit 120, the query acquisition unit 130, and the search unit 140. That is, the search system 10 according to the fourth example embodiment further includes the object detection unit 150 in addition to the configuration in the first example embodiment (see FIG. 2). The object detection unit 150 may be implemented or realized by the processor 11 (see FIG. 1), for example.

The object detection unit 150 is configured to detect an object from an image. Specifically, the object detection unit 150 is configured to detect an area in which an object exists in an image and to detect the name or type of the object. A detailed description of a specific method of detecting the object from the image will be omitted here, because existing techniques/technologies can be adopted to the method as appropriate. The object detection unit 150 may be configured as a Faster R-CNN, for example.

### (Information Addition Operation)

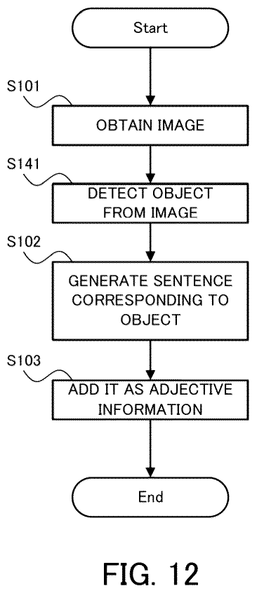

Next, an information addition operation by the search system 10 according to the fourth example embodiment will be described with reference to FIG. 12. FIG. 12 is a flowchart illustrating a flow of the information addition operation of the search system according to the fourth example embodiment. In FIG. 12, the same steps as those illustrated in FIG. 3 carry the same reference numerals.

As illustrated in FIG. 12, when the information addition operation by the search system according to the fourth example embodiment is started, first, the search system 10 obtains an image from the image storage unit 50 (step S101).

Subsequently, the object detection unit 150 detects an object from the image (step S141). Then, the sentence generation unit 110 generates a sentence corresponding to the object detected by the object detection unit 150 (step S102).

Then, the information addition unit 120 adds the sentence generated by the sentence generation unit 110, to the image as the adjective information (step S103).

### Specific Operation Example

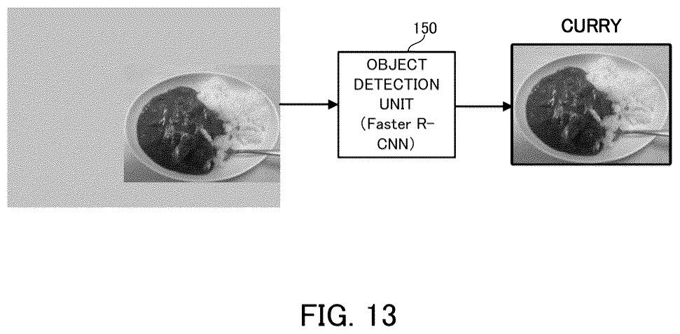

Next, a specific operation example of the search system 10 according to the fourth example embodiment (especially, the operation of the object detection unit 150) will be described with reference to FIG. 13. FIG. 13 is a conceptual diagram illustrating a specific operation of the object detection unit according to the fourth example embodiment. The following exemplifies that the object detection unit 150 is configured as a Faster R-CNN.

As illustrated in FIG. 13, it is assumed that an image (in this case, an image including a curry in an image on the right side) is inputted to the object detection unit 150 according to the fourth example embodiment. In this case, first, the object detection unit 150 extracts an area including an object (e.g., a rectangle area as illustrated in the drawing) from the image. Then, the object detection unit 150 detects that the extracted object is a curry. That is, the object detection unit 150 detects the name of the extracted object.

When the inputted image includes a plurality of objects, the object detection unit 150 may detect each of the plurality of objects. That is, the object detection unit 150 may detect a plurality of objects from a single image.

### (Technical Effect)

Next, a technical effect obtained by the search system 10 according to the fourth example embodiment will be described.

As described in FIG. 11 to FIG. 13, in the search system 10 according to the fourth example embodiment, an object included in an image is detected by the object detection unit 150. In this way, it is possible to accurately recognize the object included in the image. This allows the appropriate generation of the sentence corresponding to the object included in the image.

### Fifth Example Embodiment

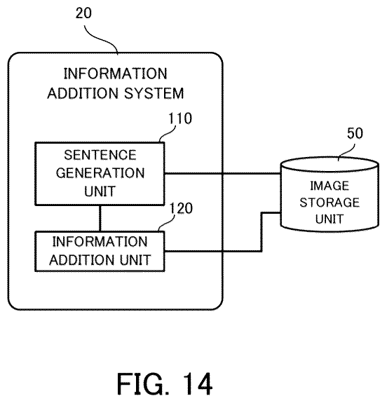

An information addition system according to a fifth example embodiment will be described with reference to FIG. 14. The information addition system according to the fifth example embodiment is partially different from the search system according to the first to fourth example embodiments only in the configuration and operation, and may be generally the same in the other parts. For this reason, a part that is different from the first to fourth example embodiments will be described in detail below, and a description of the other overlapping parts will be omitted as appropriate.

### (Functional Configuration)

First, a functional configuration of the information addition system according to the fifth example embodiment will be described with reference to FIG. 14. FIG. 14 is a block diagram illustrating the functional configuration of the information addition system according to the fifth example embodiment. In FIG. 14, the same components as those illustrated in FIG. 2 carry the same reference numerals.

As illustrated in FIG. 14, an information addition system 20 according to the fifth example embodiment includes, as processing blocks for realizing the functions thereof, the sentence generation unit 110 and the information addition unit 120. That is, the information addition system 20 according to the fifth example embodiment includes only the components related to the information addition operation, out of the configuration of the search system according to the first example embodiment (see FIG. 2). The operation of the information addition system 20 according to the fifth example embodiment may be the same as that of the information addition operation performed by the search system 10 according to the first example embodiment (see FIG. 3).

### (Technical Effect)

Next, a technical effect obtained by the information addition system 20 according to the fifth example embodiment will be described.

As described in FIG. 14, in the information addition system 20 according to the fifth example embodiment, a sentence corresponding to an object included in an image is automatically generated and is added as the adjective information. In this way, it is possible to perform various processes by using the adjective information added as the sentence.

A processing method in which a program for allowing the configuration in each of the example embodiments to operate to realize the functions of each example embodiment is recorded on a recording medium, and in which the program recorded on the recording medium is read as a code and executed on a computer, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and executes processing alone, but also the program that operates on an OS and executes processing in cooperation with the functions of expansion boards and another software, is also included in the scope of each of the example embodiments.

This disclosure is not limited to the examples described above and is allowed to be changed, if desired, without departing from the essence or spirit of this disclosure which can be read from the claims and the entire specification. A search system, a search method, and a computer program with such changes are also intended to be within the technical scope of this disclosure.

### <Supplementary Notes>

The example embodiments described above may be further described as, but not limited to, the following Supplementary Notes below.

### (Supplementary Note 1)

A search system described in Supplementary Note 1 is a search system including: a sentence generation unit that generates a sentence corresponding to an object included in an image by using a learned model; an information addition unit that adds the sentence corresponding to the object, to the image as an adjective information of the object; a query acquisition unit that obtains a search query; and a search unit that searches for an image corresponding to the search query, from a plurality of images, on the basis of the search query and the adjective information.

### (Supplementary Note 2)

A search system described in Supplementary Note 2 is the search system described in Supplementary Note 1, wherein the adjective information is information indicating a state or a situation of the object.

### (Supplementary Note 3)

A search system described in Supplementary Note 3 is the search system described in Supplementary Note 2, wherein the object is a dish, and the adjective information is information including at least one of a taste, a smell, and a temperature of the dish.

### (Supplementary Note 4)

A search system described in Supplementary Note 4 is the search system described in Supplementary Note 2, wherein the object is an article, and the adjective information is information including at least one of a texture and a tactile feel of the article.

### (Supplementary Note 5)

A search system described in Supplementary Note 5 is the search system described in any one of Supplementary Notes 1 to 4, wherein the search query is a natural language.

### (Supplementary Note 6)

A search system described in Supplementary Note 6 is the search system described in any one of Supplementary Notes 1 to 5, wherein the learned model includes: an extraction model for extracting a feature quantity of the object from the image; and a generation model for generating a sentence corresponding to the object from the feature quantity of the object.

### (Supplementary Note 7)

A search system described in Supplementary Note 7 is the search system described in any one of Supplementary Notes 1 to 6, wherein the search unit searches for the image corresponding to the search query, on the basis of a similarity degree between a feature vector generated from the search query and a feature vector generated from the adjective information.

### (Supplementary Note 8)

A search system described in Supplementary Note 8 is the search system described in Supplementary Note 7, wherein the search unit extracts a word that is usable for a search from the search query and the adjective information, and generates the feature vector on the basis of the extracted word.

### (Supplementary Note 9)

A search system described in Supplementary Note 9 is the search system described in any one of Supplementary Notes 1 to 8, further including an object detection unit that detects the object from the image, wherein the sentence generation unit generates a sentence corresponding to the object detected by the object detection unit.

### (Supplementary Note 10)

A search system described in Supplementary Note 10 is the search system described in any one of Supplementary Notes 1 to 9, wherein the search unit searches for the image corresponding to the search query, by using at least one of a time information indicating a time when the image is captured, a position information indicating a position where the image is captured, and a name information indicating a name of the object, in addition to the adjective information.

### (Supplementary Note 11)

A search system described in Supplementary Note 11 is the search system described in any one of Supplementary Notes 1 to 10, wherein the search unit searches for the image corresponding to the search query, from a plurality of images that constitute video data.

### (Supplementary Note 12)

A search method described in Supplementary Note 12 is a search method including: generating a sentence corresponding to an object included in an image by using a learned model; adding the sentence corresponding to the object, to the image as an adjective information of the object; obtaining a search query; and searching for an image corresponding to the search query, from a plurality of images, on the basis of the search query and the adjective information.

### (Supplementary Note 13)

A computer program described in Supplementary Note 13 is a computer program that operates a computer: to generate a sentence corresponding to an object included in an image by using a learned model; to add the sentence corresponding to the object, to the image as an adjective information of the object; to obtain a search query; and to search for an image corresponding to the search query, from a plurality of images, on the basis of the search query and the adjective information.

### (Supplementary Note 14)

A recording medium described in Supplementary Note 14 is a recording medium on which the computer program described in Supplementary Note 13 is recorded.

### DESCRIPTION OF REFERENCE CODES

10 Search system
11 CPU
50 Image storage unit
110 Sentence generation unit
111 Extraction model
112 Generation model
120 Information addition unit
130 Query acquisition unit
140 Search unit
141 Word extraction unit
142 Feature vector generation unit
143 Similarity calculation unit
150 Object detection unit

What is claimed is:

1. A search system comprising:
at least one memory that is configured to store instructions; and
at least one first processor that is configured to execute the instructions to
generate a sentence corresponding to an object included in an image by using a learned model;
add the sentence corresponding to the object, to the image as an adjective information of the object;
obtain a search query; and
search for an image corresponding to the search query, from a plurality of images, on the basis of the search query and the adjective information.

2. The search system according to claim 1, wherein the adjective information is information indicating a state or a situation of the object.

3. The search system according to claim 2, wherein
the object is a dish, and
the adjective information is information including at least one of a taste, a smell, and a temperature of the dish.

4. The search system according to claim 2, wherein
the object is an article, and
the adjective information is information including at least one of a texture and a tactile feel of the article.

5. The search system according to claim 1, wherein the search query is a natural language.

6. The search system according to claim 1, wherein the learned model includes: an extraction model for extracting a feature quantity of the object from the image; and a generation model for generating a sentence corresponding to the object from the feature quantity of the object.

7. The search system according to claim 1, wherein the at least one first processor is configured to execute the instructions to search for the image corresponding to the search query, on the basis of a similarity degree between a feature vector generated from the search query and a feature vector generated from the adjective information.

8. The search system according to claim 7, wherein the at least one first processor is configured to execute the instructions to extract a word that is usable for a search from the search query and the adjective information, and generate the feature vector on the basis of the extracted word.

9. The search system according to claim 1, further comprising a second processor that is configured to execute the instructions to detect the object from the image, wherein
the at least one first processor is configured to execute the instructions to generate a sentence corresponding to the object detected.

10. The search system according to claim 1, wherein the at least one first processor is configured to execute the instructions to search for the image corresponding to the search query, by using at least one of a time information indicating a time when the image is captured, a position information indicating a position where the image is captured, and a name information indicating a name of the object, in addition to the adjective information.

11. The search system according to claim 1, wherein the at least one first processor is configured to execute the instructions to search for the image corresponding to the search query, from a plurality of images that constitute video data.

12. A search method comprising:
generating a sentence corresponding to an object included in an image by using a learned model;
adding the sentence corresponding to the object, to the image as an adjective information of the object;
obtaining a search query; and
searching for an image corresponding to the search query, from a plurality of images, on the basis of the search query and the adjective information.

13. A non-transitory recording medium on which a computer program that allows a computer to execute a search method is recorded, the search method including:
generating a sentence corresponding to an object included in an image by using a learned model;
adding the sentence corresponding to the object, to the image as an adjective information of the object;
obtaining a search query; and
searching for an image corresponding to the search query, from a plurality of images, on the basis of the search query and the adjective information.
